(19) United States
(12) Patent Application Publication
(10) Pub. No.: US 2025/0270118 A1
(43) Pub. Date: Aug. 28, 2025

(54) WATER FILTRATION MEMBRANES AND SYSTEMS

(71) Applicant: Khalifa University of Science and Technology, Abu Dhabi (AE)

(72) Inventors: Shadi Wajih HASAN, Abu Dhabi (AE); Mariam OUDA, Abu Dhabi (AE); Ravi P. PANDEY, Abu Dhabi (AE)

(21) Appl. No.: 18/590,525

(22) Filed: Feb. 28, 2024

(51) Int. Cl. C02F 1/44; B01D 61/42; B01D 71/02; B01D 71/68; C02F 1/463; C02F 101/30

(52) U.S. Cl. CPC C02F 1/444; C02F 1/463; B01D 61/425; B01D 71/02; B01D 71/68; B01D 2325/02832; B01D 2325/02833; C02F 2101/30

(57) ABSTRACT

A composite filtration membrane includes sulfonated polyethersulfone (SPES) and one or more MXenes. A filtration apparatus includes a cathode, wherein the cathode includes a composite filtration membrane including a polymer and one or more MXenes; and a sacrificial anode.

### BACKGROUND

Water scarcity represents a significant global issue, affecting millions who lack access to clean water. Meeting the demand for top-quality water necessitates the implementation of efficient and sustainable methods of water purification. Desalination has emerged as a viable freshwater source on a global scale. Among the various technologies, reverse osmosis (RO) plants have emerged as a promising solution, effectively removing salts. Unfortunately, the overuse of plastics has led to a large influx of microplastics (MPs) in water bodies and water/wastewater treatment plants. Coupled with the ongoing water crisis, this poses a threat to freshwater availability as microplastics disrupt the operation of these plants, since microplastics cause severe fouling of low-pressure membrane technologies due to the strong adhesion between microplastics and the membrane surface.

Accordingly, membranes require efficient pre-treatment procedures to eliminate contaminants other than salts, with the goal of reducing the high-pressure demands during reverse osmosis unit operations. Recently, chemical coagulation has been utilized upstream of reverse osmosis operations for pre-treatment to reduce residence time. However, the use of chemical coagulants elevates costs and poses health and safety concerns. Embodiments of the present disclosure provide novel membrane materials and filtration systems for removing contaminants from water. Further, these filtration systems of the present disclosure are capable of operating (and removing contaminants) without the use of added chemicals.

### SUMMARY

According to one aspect, a composite filtration membrane includes sulfonated polyethersulfone (SPES) and one or more MXenes.

According to another aspect, a filtration apparatus includes a cathode, wherein the cathode includes a composite filtration membrane including a polymer and one or more MXenes; and a sacrificial anode.

According to another aspect, a cathode includes a composite filtration membrane including one or more polymeric materials and one or more MXenes.

According to another aspect, a method of filtering water includes providing a filtration system including a cathode and an anode; and contacting water with the cathode and the anode, to produce a permeate stream, wherein the cathode includes a composite filtration membrane including a polymer and one or more MXenes.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates method 100 of forming a composite filtration membrane, according to some embodiments.

FIG. 2 illustrates water filtration system 200, according to some embodiments.

FIG. 3 illustrates method 300 of filtering water, according to some embodiments.

FIG. 4A illustrates a synthesis method for Ti₃C₂Tₓ, according to some embodiments.

FIG. 4B illustrates a synthesis method for SPES, according to some embodiments.

FIG. 4C illustrates a fabrication method for a SPES/Ti₃C₂Tₓ composite membrane, according to some embodiments.

FIG. 5A illustrates Raman spectra for SPES/Ti₃C₂Tₓ composites, according to some embodiments.

FIG. 5B illustrates Fourier Transform Infrared (FTIR) spectra, according to some embodiments.

FIG. 6A illustrates x-ray powder diffraction (XRD) diffractograms of PES, SPES, and SPES/Ti₃C₂Tₓ composites, according to some embodiments.

FIG. 6B illustrates energy-dispersive x-ray spectroscopy (EDS) spectra of PES, according to some embodiments.

FIG. 6C illustrates EDS spectra of SPES, according to some embodiments.

FIG. 6D illustrates EDS spectra of SM5, according to some embodiments.

FIG. 6E illustrates EDS spectra of SM10, according to some embodiments.

FIG. 6F illustrates EDS spectra of SM15, according to some embodiments.

FIG. 7A illustrates the static contact angle and surface energy of PES, SPES, SM5, SM10, and SM15, according to some embodiments.

FIG. 7B illustrates the dynamic contact angle of PES, SPES, SM5, SM10, and SM15, according to some embodiments.

FIG. 7C illustrates the pore size and porosity of PES, SPES, SM5, SM10, and SM15, according to some embodiments.

FIG. 7D illustrates cross-sectional scanning electron microscope (SEM) micrographs of PES, SPES, SM5, SM10, and SM15, according to some embodiments.

FIG. 8 illustrates a system for water filtration, according to some embodiments.

FIG. 9A illustrates a schematic of a cross-flow electrified filtration system, according to some embodiments.

FIG. 9B illustrates components of the cell assembly, according to some embodiments.

FIG. 10A illustrates the pure water permeability (PWP) of PES, SPES, SM5, SM10, and SM15, according to some embodiments.

FIG. 10B illustrates the flux of microplastic-rich suspensions using PES, SPES, SM5, SM10, and SM15, according to some embodiments.

FIG. 11A illustrates the effect of voltage on cross-flow filtration flux of a microplastic-rich suspension, according to some embodiments.

FIG. 11B illustrates potential and current characteristics of PES, SPES, SM5, SM10, and SM15, according to some embodiments.

FIG. 11C illustrates the electrical conductivity of PES, SPES, SM5, SM10, and SM15, according to some embodiments.

FIG. 12A illustrates the long-term effect of applied voltage on cross-flow filtration flux of micro-plastic rich suspensions using PES, according to some embodiments.

FIG. 12B illustrates the long-term effect of applied voltage on cross-flow filtration flux of micro-plastic rich suspensions using SPES, according to some embodiments.

FIG. 12C illustrates the long-term effect of applied voltage on cross-flow filtration flux of micro-plastic rich suspensions using SM5, according to some embodiments.

FIG. 12D illustrates the long-term effect of applied voltage on cross-flow filtration flux of micro-plastic rich suspensions using SM10, according to some embodiments.

FIG. 12E illustrates the long-term effect of applied voltage on cross-flow filtration flux of micro-plastic rich suspensions using SM15, according to some embodiments.

FIG. 13 illustrates cross-flow filtration flux of microplastic-rich suspensions using SM5 in intermittent applied voltage mode, according to some embodiments.

FIG. 14 illustrates a mechanism for the effect of intermittent voltage on the membranes of the present disclosure, according to some embodiments.

### DETAILED DESCRIPTION

Embodiments of the present disclosure include novel membranes, filtration systems, and methods of filtering water. Membranes of the present disclosure generally include composite filtration membranes. For example, the composite filtration membrane can include a combination of two or more components with different physical and/or chemical properties. These composite filtration membranes can be utilized for various filtration applications, such as ultrafiltration and nanofiltration. Further, filtration systems of the present disclosure are capable of operating (and removing contaminants) without the use of added chemicals.

The composite filtration membrane may include one or more polymeric materials. In one example, the one or more polymeric materials include at least one of polysulfone, polyethersulfone (PES), polyvinylidene fluoride (PVDF), and polyvinyl chloride (PVC). In another example, the polymeric material is functionalized with sulfonate groups. Accordingly, the polymeric material may be sulfonated. For example, the polymeric material may include sulfonated polyethersulfone (SPES). Sulfonated polyethersulfone may be formed by a sulfonation reaction with polyethersulfone. For example, sulfuric acid may be contacted with dry polyethersulfone to form sulfonated polyethersulfone. In one example, the weight percentage of SPES in the composite filtration membrane ranges from about 70 wt. % to about 99.9 wt. %. In another example, the weight percentage of SPES in the composite filtration membrane ranges from about 80 wt. % to about 99.8 wt. %.

Sulfonation can decrease the surface charge of the composite filtration membrane, making it more negative. A decreased surface charge can increase the hydrophilicity and pure water permeability of the membrane and the liquid flux through the membrane. Sulfonation can also resist fouling due to the presence of functional groups on the polymer backbone. In one non-limiting example, the polymeric materials include SPES and polyvinylpyrrolidone (PVP). In one example, the weight percentage of PVP in the composite filtration membrane ranges from about 0.2 wt. % to about 5 wt. %. In another example, the weight percentage of PVP in the composite filtration membrane ranges from about 1 wt. % to about 2 wt. %. Additionally, the composite filtration membrane may be in contact with a membrane support, such as a polypropylene/polyethylene membrane support.

The composite filtration membrane may include sulfonate groups, wherein the degree of sulfonation ranges from 1% to 40%. In one example, the composite filtration membrane includes sulfonate groups, wherein the degree of sulfonation of polyethersulfone ranges from 1% to 40%. In another example, the composite filtration membrane includes sulfonate groups, wherein the degree of sulfonation of polyethersulfone ranges from 10% to 32%. The degree of sulfonation of polyethersulfone may be greater than 20%. As stated, sulfonation can decrease the surface charge of the composite filtration membrane, such that the negative surface charge increases. Further, sulfonation can add additional hydrophilic groups to the membrane, resulting in higher water flux.

The composite filtration membrane may include titanium, wherein the weight percentage of titanium in the composite filtration membrane ranges from about 0.1 wt. % to about 15 wt. %. In one example, the composite filtration membrane includes titanium, wherein the weight percentage of titanium in the composite filtration membrane ranges from about 0.2 wt. % to about 10 wt. %. In another example, the composite filtration membrane includes titanium, wherein the weight percentage of titanium in the composite filtration membrane ranges from about 0.2 wt. % to about 5 wt. %. The weight percentage of titanium in the composite filtration membrane may be greater than 0.5 wt. %. The weight percentage of titanium in the composite filtration membrane may be less than 3 wt. %. Since titanium in the composite filtration membrane may be present from one or more MXenes (discussed in a subsequent paragraph), the weight percentage of titanium is important for electrical conductivity, water flux, and structural strength.

The composite filtration membrane may include one or more MXenes. In one example, MXene is a 2D nanomaterial made up of a single layer of transition metal atoms between layers of carbon atoms. MXenes feature adjustable surface properties and excellent mechanical strength. The MXene(s) may be present as exfoliated, 2D nanosheets, and the MXene(s) can be homogenously distributed in the bulk of the membrane. 2D nanosheets may be a single-layer thick. In one example, the MXene follows the formula:Mₙ₊₁XₙTₓ, where M is early transition metals (Ti, V, Cr, Y, Zr, Nb, Mo, Hf, Ta, or W), X is C or N, Tₓ is surface terminations such as OH, O, F, and/or Cl, and n is 1, 2, or 3. The metal (M) may be selected based on the desired electrical conductivity of the composite filtration membrane. In another example, the MXene includes Ti. For example, the MXene may have the following formula: Ti₃C₂Tₓ, where Tₓ is selected from OH, O, F, and/or Cl.

The weight percentage of MXene in the composite filtration membrane may range from about 0.1 wt. % to about 30 wt. %. In one example, the weight percentage of MXene in the composite filtration membrane ranges from about 0.2 wt. % to about 20 wt. %. In another example, the MXene includes titanium and the weight percentage of MXene in the composite filtration membrane ranges from about 0.2 wt. % to about 20 wt. %. The weight percentage of MXene in the composite filtration membrane may be greater than 2 wt. %, greater than 4 wt. %, or greater than 10 wt. %.

Ti₃C₂Tₓ can be distributed in the bulk of the membrane with excellent stability and attachment with a sulfonated polymeric material. Importantly, the Ti₃C₂Tₓ MXene has a number of unique properties, such as a large surface area, excellent mechanical strength, high hydrophilicity, low density, and the ability to withstand harsh water treatment conditions. Further, compared to graphene oxide nanomaterial, which is permeable but lacks conductivity, the Ti₃C₂Tₓ MXene has a high electrical conductivity. The Ti₃C₂Tₓ MXene can include hydrophilic groups, such as —OH and —O, resulting in a lower contact angle and higher surface energy. Further, the MXene(s) can add anti-fouling properties to the composite filtration membrane.

Composite filtration membranes of the present disclosure may exhibit an increased pore size compared to a conventional polyethersulfone membrane. A membrane characterized with higher pore size and porosity exhibits an increase in the interlinked void spaces. This, in turn, can facilitate higher flux and enhanced permeability. An increased number of pores leads to more pathways for the substance to travel through, resulting in increased transport rates. However, excessively high porosity might lead to reduced structural stability. Hence, a balanced distribution of small and large pores can enhance the overall transport efficiency. This balanced distribution may be obtained from using certain weight percentages (of the present disclosure) of MXene components and polymeric materials. Smaller pores may block larger molecules, while larger pores might allow faster movement of smaller molecules. The composite filtration membrane may include a skin layer having small finger-like pores for high selectivity and a macro-void layer having larger pores for higher mass transfer.

The composite filtration membrane may be an ultrafiltration membrane or a nanofiltration membrane. In one example, the composite filtration membrane has an average pore size ranging from about 1 nm to about 100 nm. In another example, the composite filtration membrane has an average pore size ranging from about 40 nm to about 90 nm. In yet another example, the composite filtration membrane has an average pore size ranging from about 60 nm to about 90 nm. The composite filtration membrane may have a porosity ranging from about 40% to about 80%. In one example, the composite filtration membrane has a porosity ranging from about 50% to 65%. Porosity ranges of the present disclosure are important for high flux and enhanced permeability without sacrificing structural stability.

The static water contact angle of the composite filtration membrane may range from about 50° to about 85°. In one example, the static water contact angle of the composite filtration membrane ranges from about 55° to about 85°. In another example, the static water contact angle of the composite filtration membrane ranges from about 60° to about 80°. The surface energy of the composite filtration membrane may range from about 80 MJ/m² to about 120 MJ/m². In one example, the surface energy of the composite filtration membrane may range from about 90 MJ/m² to about 110 MJ/m². In one example, MXene and SPES composite filtration membranes of the present disclosure have increased surface energy compared to conventional membranes. This increased surface energy can lead to the formation of a thicker hydration later, which allows higher mass transfer of water through the membrane.

The pure water permeability of the composite filtration membrane may range from about 50 L.m⁻².h⁻¹.bar⁻¹ to 300 L.m⁻².h⁻¹.bar⁻¹. In one example, the pure water permeability of the composite filtration membrane ranges from about 200 L.m⁻².h⁻¹.bar⁻¹ to 300 L.m⁻².h⁻¹.bar 1. In another example, the pure water permeability of the composite filtration membrane ranges from about 225 L.m⁻².h⁻¹.bar⁻¹ to 280 L.m⁻².h⁻¹.bar⁻¹. In one non-limiting example, the pure water permeability of a composite membrane including Ti₃C₂Tₓ may be greater than 200 L.m⁻².h⁻¹.bar⁻¹, greater than 225 L.m⁻².h⁻¹.bar⁻¹, and/or greater than 250 L.m⁻².h⁻¹.bar⁻¹.

Membranes of the present disclosure can be electro-conductive membranes. Accordingly, these membranes exhibit one or more of elevated flux, anti-fouling properties, and selective separation of charged species. The electrical conductivity of the composite filtration membrane may range from 20 mS/m to 50 mS/m. In one example, the electrical conductivity of the composite filtration membrane ranges from 25 mS/m to 40 mS/m. In another example, the electrical conductivity of the composite filtration membrane ranges from 25 mS/m to 35 mS/m. In yet another example, the electrical conductivity of the composite filtration membrane is greater than 10 mS/m. Importantly, a Ti₃C₂Tₓ composite membrane of the present disclosure may be greater than 3×, greater than 5×, greater than 8×, or greater than 10× more electrically conductive compared to a conventional polyethersulfone membrane.

Importantly, composite filtration membranes of the present disclosure can be used as a pre-treatment membrane for desalination. Compared to conventional pre-treatment methods that use membranes that foul easily and require an additional chemical/electro coagulation stage, membranes of the present disclosure are capable of being permeable and electrically conductive for electrocoagulation without using an additional stage, such as an additional chemical coagulation stage. For example, membranes of the present disclosure may be used in a single unit operation for ultrafiltration and electrocoagulation.

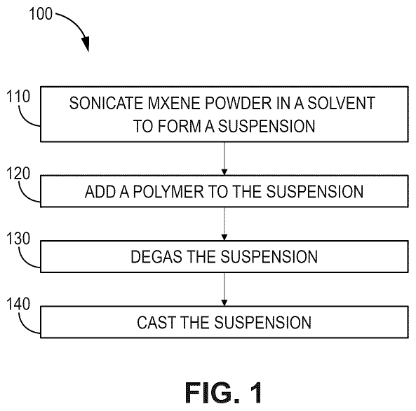

Referring to FIG. 1, method 100 for making a composite filtration membrane includes the following steps:

STEP 110, SONICATING MXENE POWDER IN A SOLVENT TO FORM A SUSPENSION, includes sonicating MXene(s) (such as a Ti MXene) with a solvent, such as N-methyl-2-pyrrolidone (NMP), to form a suspension. STEP 110 may include forming a solution. In one example, sonicating may be performed for 30 minutes to 90 minutes. A polymer, such as polyvinylpyrrolidone (PVP), may be added to the sonicated suspension during or after sonication. Then, the suspension may be sonicated again. In one example, the subsequent sonication may be performed for 30 minutes to 90 minutes.

The MXene powder may formed by creating a reaction mixture with a MAX phase component. In the MAX component, M is a transition metal (e.g., scandium, yttrium, lutetium, titanium, zirconium, hafnium, vanadium, niobium, tantalum, chromium, molybdenum, tungsten, manganese, or iron); A is a Group A element (e.g., iridium, palladium, copper, gold, zinc, cadmium, aluminum, gallium, indium, thallium, silicon, germanium, tin, lead, phosphorous, arsenic, bismuth, or sulfur); and X is carbon and/or nitrogen. Then, etch the A element layer from the lattice structure to form an intercalated lattice. For example, a mixture of LiF, HCl, and the MAX component may be used to etch the A element. Then, centrifuge the resulting mixture to obtain a solid residue. The solid residue can then be washed several times with DI water. The obtained solid residue can then be re-dispersed in DI water using sonication to exfoliate the layers, leading to the development of 2D nanosheets. Finally, the solution can be freeze-dried to obtain exfoliated 2D nanosheets. For example, Ti₃C₂Tₓ MXene may be formed from the Ti₃AlC₂ MAX component.

STEP 120, ADDING A POLYMER TO THE SUSPENSION, includes adding a polymer, such as SPES powder, to the suspension. Adding the polymer to the suspension may include stirring to mix the suspension and/or heating the suspension. In one example, the suspension is stirred at 50 rpm to 250 rpm. The suspension may be stirred until it is homogeneous. The suspension may be stirred for 1 or more hours, 4 or more hours, or 12 or more hours. In another example, the suspension is heated to/at a temperature ranging from 40° C. to 90° C.

SPES may be formed from PES. In one example, PES pellets are dried at a temperature between about 40° C. and 80° C. Then, the PES can be dissolved in concentrated sulfuric acid. This solution can be stirred and/or heated. For example, the solution is heated to/at a temperature ranging from about 40° C. to 70° C. at 100 rpm to 500 rpm. After completion, or substantial completion of the sulfonation reaction, the solution may be cooled and the SPES can be rinsed to remove excess acid. Finally, the SPES may be dried under vacuum at a temperature ranging from about 40° C. to about 80° C. For example, SPES may be dried under vacuum at a temperature of about 60° C.

In one example, the weight percentage of SPES in the suspension ranges from 10 wt. % to 20 wt. %. For example, the weight percentage of SPES in the suspension may be about 16 wt. %. In another example, the weight percentage of PVP in the suspension may range from about 1 wt. % to about 4 wt. %. For example, the weight percentage of PVP in the suspension may be about 2 wt. %. In yet another example, the weight percentage of MXene in the suspension may range from about 1 wt. % to about 15 wt. %. Accordingly, the weight percentage of MXene in the suspension may range from 2 wt. % to 10 wt. %. For example, the weight percentage of a Ti₃C₂Tₓ MXene in the suspension may range from about 4 wt. % to about 7 wt. %.

STEP 130, DEGASSING THE SUSPENSION, includes degassing the suspension to minimize macropores in the formed membrane. Degassing may include removing one or more dissolved gases from the liquid. In one example, degassing is performed for about 30 minutes to about 90 minutes. In another example, degassing is performed for about 60 minutes.

STEP 140, CASTING THE SUSPENSION, includes casting on a plate, such as a glass plate with a casting knife. In one example, the suspension may be cast on a glass plate using a 200 μm casting knife. STEP 140 may further include placing the cast suspension in a coagulation bath, such as a water coagulation bath. In one example, the temperature of the water coagulation bath ranges from about 20° C. to about 40° C. Accordingly, method 100 may be utilized to form the composite filtration membranes of the present disclosure. These composite filtration membranes may be added to a support, such as a polypropylene/polyethylene membrane support.

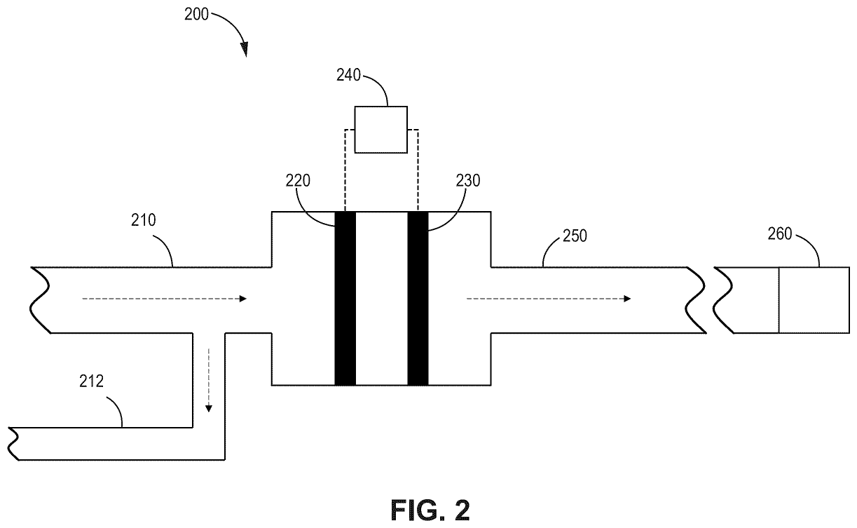

FIG. 2 illustrates a water filtration system 200 (filtration apparatus), according to some embodiments. Water filtration system 200 includes inlet 210, optional recycle 212, anode 220, membrane 230, power supply 240, and outlet 250. Water filtration system 200 may further include a downstream process 260, such as a reverse-osmosis system. Inlet 210 may receive and/or transfer fluid(s) from a fluid source to anode 220 and/or membrane 230. Accordingly, inlet 210 may include a pipe, pump, and/or conduit suitable for liquid transfer. Membrane 230 includes a composite filtration membrane of the present disclosure. Importantly, membrane 230 can function as both a membrane and as a cathode. Permeated fluid may exit membrane 230 and system 200 via outlet 250. Outlet 250 can transfer permeated fluid to optional downstream process 260, such as a downstream reverse-osmosis system. Accordingly, filtration system 200 may be utilized as a pre-treatment system for reverse-osmosis. For example, a reverse-osmosis membrane may have a pore size ranging from about 0.1 nm to about 1 nm.

As discussed, inlet 210 may receive and transfer fluid(s) from a fluid source to anode 220 and/or membrane 230. In one example, the fluid includes water. The water may include microplastics and/or salts. For example, microplastics may be small plastic particles less than about 5 mm in size. These microplastics may be found in various water sources such as lakes, rivers, and oceans. Microplastics cause severe fouling issues for water filtration membranes, such as a reverse-osmosis membrane. Examples of microplastics include polypropylene, polyvinyl chloride, polystyrene, and polyethylene. Optional recycle 212 may recycle fluid(s) from inlet 210 back to a feed source or back to inlet 210.

Anode 220 (such as a sacrificial anode) and membrane 230 are electrically connected to power supply 240. Anode 220 is electrically connected to a positive terminal of power supply 240, and membrane 230 functions as the cathode and is electrically connected to a negative terminal of power supply 240. In one example, anode 220 is a sacrificial anode in fluidic communication with membrane 230. As voltage is applied to membrane 230, electrons flow from anode 220 to power supply 240. Compared to conventional anodes used as sacrificial anodes to disinfect free radicals, anode 220 assists with electrocoagulation without using chemicals. In one example, anode 220 includes one or more of iron and aluminum. In another example, anode 220 includes aluminum, and aluminum is dissociated from the anode to generate Al³⁺ when water is flowing past or through anode 220 and voltage is applied. These Al³⁺ coagulants can combine with OH—(formed at membrane 230) to form hydroxyl aluminum ions. The hydroxyl group then polymerizes with another Al³⁺ to form a two-hydroxyl bond bridge (Alₘ(H₂O)×(OH)ₙ^{(3m-n)+}). The mononuclear aluminum complex can further polymerize forming an Al(OH) 3 amorphous flocculant. These complexes can capture and sweep microplastics by netting or entangling the microplastics in the water due to the large surface area and functional groups of the complex.

As discussed, membrane 230 may function as the cathode. Accordingly, the cathode in filtration system 200 includes a composite filtration membrane including a polymer and one or more MXenes. In one example, the polymer includes polyethersulfone (PES). In another example, the polymer includes sulfonated polyethersulfone (SPES). In one example, the MXene follows the formula:Mₙ₊₁XₙTₓ, where M is early transition metals (Ti, V, Cr, Y, Zr, Nb, Mo, Hf, Ta, or W), X is C or N, Tₓ is surface terminations such as OH, O, F, and/or CI, and n is 1, 2, or 3. In another example, the MXene includes Ti. For example, the MXene may have the following formula: Ti₃C₂Tₓ, where Tₓ is selected from OH, O, F, and/or Cl. Since membrane 230 is electrically conductive, power supply 240 applies a voltage for electro-coagulation and to increase the water flux through membrane 230.

In one example, power supply 240 applies a voltage between about 0.1 V and about 10 V. In another example, power supply 240 applies a voltage between about 0.1 V and about 5 V. In yet another example, power supply 240 applies a voltage between about 1 V and about 3 V. In one non-limiting example, a voltage of less than 5 V is applied to increase the degree of polymerization. By increasing the degree of polymerization, larger flocs can be formed and swept away from the membrane surface. Further, applying voltage to membrane 230 can increase the water flux by over 70%, by over 80%, or by over 90% compared to water flowing through a conventional, non-conductive polymeric membrane.

Intermittent operation of applied voltage can result in more stable water flux due to in-situ coagulant formation and cleaning. When voltage is applied to membrane 230, the liquid flux through membrane 230 increases. In one example, the liquid flux through membrane 230 increases due to the electrostatic repulsion exerted on negatively charged particles by the electric field at membrane 230. For example, ions from anode 220 dissolve and polymerize with the hydroxyl groups formed at the cathode, forming an in-situ flocculant that forms large flocs with microplastics in the bulk solution. Therefore, pore blockage can be terminated, and large flocs form a cake creating a heterogenous surface. When excessive flocs form on the surface of membrane 230, the electric field can be turned off and the flocs can be removed/swept from the surface of membrane 230. Accordingly, intermittent voltage operation can maintain a more stable flux because it allows for in-situ coagulant formation and an in-situ cleaning procedure without the need for additional chemicals such as chemical flocculants or cleaning agents.

In one example, intermittent operation includes repeating the process of providing voltage and switching the electric field off. For example, voltage can be applied to membrane 230 for 10 minutes to 100 minutes, and power supply 240 can then be turned off for 10 minutes to 100 minutes. This cycle may be repeated throughout the operation of filtration system 200. In another example, voltage can be applied to membrane 230 for about 20 minutes to 40 minutes, and power supply 240 can then be turned off for about 50 minutes to about 70 minutes. In yet another example, in an intermittent operation cycle of filtration system 200, power supply 240 may be turned off for more time than power supply 240 is applying voltage to membrane 230. This allows sufficient time for coagulant formation and cleaning.

Permeated fluid may exit membrane 230 and filtration system 200 via outlet 250. Outlet 250 may be in fluidic communication with membrane 230. Further, outlet 250 may transfer permeated fluid(s) to downstream process 260, such as a downstream filtration system. In one example, outlet 250 transfers permeated fluid(s) to a downstream reverse-osmosis filtration system. Since microparticles/nanoplastics can be electrocoagulated and removed using filtration system 200, severe microplastic fouling of downstream processes will be negated. Further, since filtration system 200 can be operated at a relatively low voltage, filtration system 200 provides an efficient and low-cost filtration process for pre-treatment of water in desalination processes without using harmful chemical additives.

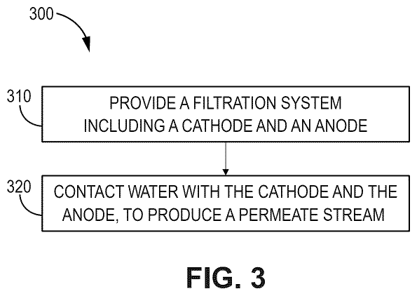

Referring to FIG. 3, method 300 of filtering water is provided. Method 300 includes the following steps:

STEP 310, PROVIDING A FILTRATION SYSTEM INCLUDING A CATHODE AND AN ANODE, includes providing a system of the present disclosure, such as filtration system 200. Filtration system 200 includes membrane 230, where membrane 230 is capable of operating as the filtration membrane and the cathode. Anode 220 is one example of a suitable anode for method 300; and

STEP 320, CONTACTING WATER WITH THE CATHODE AND THE ANODE, TO PRODUCE A PERMEATE STREAM, includes contacting water, and optionally additional fluid(s), with the cathode (such as membrane 230) and the anode (such as anode 220). The water may be transferred from various sources such as the ocean, lakes, rivers, and water treatment plants. In one example, the water includes microplastics. The overuse of plastics has led to a large influx of microplastics in water bodies and water/wastewater treatment plants. Microplastics cause severe fouling of low-pressure membrane technologies such as ultrafiltration membranes due to the strong adhesion between microplastics and the membrane surface. Importantly, method 300 and filtration system 200 can be used to remove these microplastics from the water.

Method 300 may further include applying a voltage to the cathode, wherein the voltage ranges from about 0.1 volts to about 10 volts. In one example, the applied voltage ranges from about 0.1 volts to about 5 volts. For example, the applied voltage may be about 1 volt, about 2 volts, or about 3 volts. This voltage may be applied in an intermittent operation, as previously discussed in the present disclosure. Accordingly, the application of voltage may be ceased to assist in removing electrocoagulated microparticles from the surface of membrane 230. These microparticles may include microplastics.

Importantly, compared to pre-treatment filtration systems that require large amounts of chemicals for coagulation, systems and methods of the present disclosure do not require these expensive chemical additives, such as chemical flocculants and chemical cleaning agents. Further, filtration system 200 is capable of maintaining steady water flux through membrane 230 while cleaning microplastics from the surface of membrane 230. Since membrane 230 is uniquely permeable and electrically conductive, membrane 230 can operate with electrostatic repulsion to increase hydrophilicity, increase water flux, and decrease particle fouling.

### Example 1

Materials utilized include: poly(vinylpyrrolidone) (PVP; Mw: 40000 Da), lithium fluoride (LiF; powder ˜300 mesh), sulfuric acid (H₂SO₄; 96%), N-Methyl-2-pyrrolidone (NMP; 99.5%), Tween® (Polysorbate) 80, hydrochloric acid (HCl; 36-38.5% w/w), sodium hydroxide (NaOH; Mw: 39.99 g/mol), titanium aluminum carbide (MAX; 312, >90%, <40 μm particle size), polyethersulfone pellets (PES; Mw: 58 kDa), polyethylene (PE) microspheres, de-ionized water (resistivity: 15 MΩ·cm, 23° C.), and a non-woven polypropylene/polyethylene membrane support.

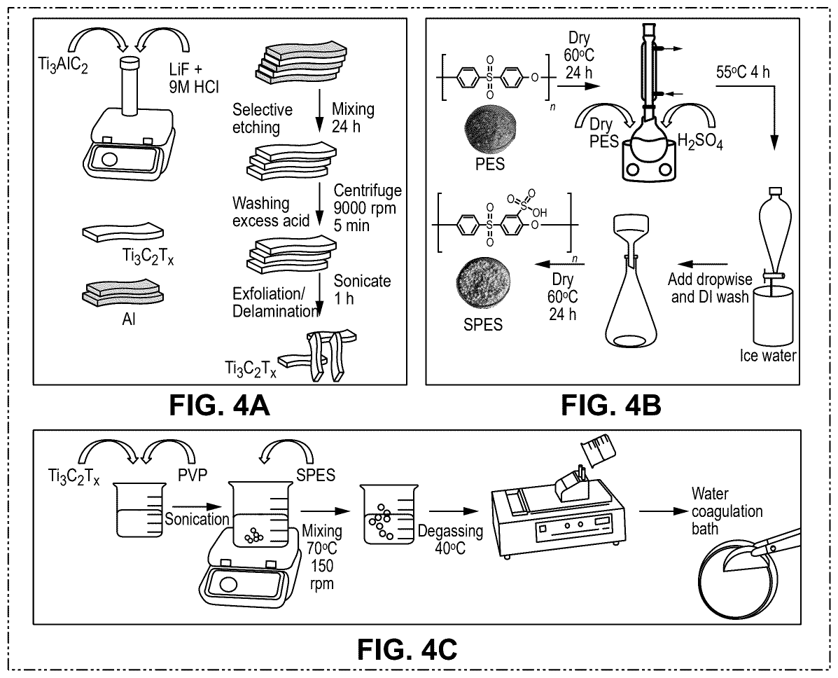

FIG. 4A illustrates a synthesis method for Ti₃C₂Tₓ MXene, according to some embodiments. Ti₃C₂Tₓ was synthesized by first dissolving 400 mg of LiF in 5 mL of 9M HCl. After complete dissolution, 250 mg of MAX phase (Ti₃AlC₂) was added and the resulting reaction mixture was magnetically stirred at 25° C. for 24 h. This process was used to etch the Al layer from the lattice structure, resulting in an intercalated Ti₃C₂Tₓ lattice. Finally, the resulting mixture was centrifuged at 9000 rpm for 5 min to obtain a solid residue. The solid residue was washed several times with DI water by repeated centrifugation at 9000 rpm for 5 min to remove excess HCl until a pH of >5 was achieved. The solid residue obtained was re-dispersed in DI water (40 mL) by bath sonication (10 min) to exfoliate the layers, leading to the development of the 2D nanosheets. Finally, the solution was freeze-dried to obtain exfoliated 2D nanosheets of Ti₃C₂Tₓ.

FIG. 4B illustrates a synthesis method for SPES, according to some embodiments. The sulfonation process starts with drying the PES pellets overnight at 60° C. Then, 15 g of PES was dissolved in 200 mL of concentrated H₂SO₄. The solution was kept on a magnetic stirrer at a temperature of 55° C. for 4 h under stirring at 300 rpm. The prepared solution was poured dropwise into ice-cold DI water after completion of the sulfonation reaction to obtain the SPES. The SPES were washed thoroughly with DI water several times to get rid of the excess acid. Finally, the SPES was dried under vacuum overnight at 60° C.

FIG. 4C illustrates a fabrication method for a SPES/Ti₃C₂Tₓ composite membrane, according to some embodiments. The obtained SPES and Ti₃C₂Tₓ powders were used for the preparation of the membranes. Ti₃C₂Tₓ was first sonicated in a sufficient amount of NMP for 1 h. Then PVP was added and sonicated for another hour. Subsequently, PES or SPES was added, depending on the desired membrane composition (Table 1), and the suspension was stirred for 24 h until it was homogeneous. The suspension was then degassed for an additional 1 h to minimize the formation of macropores in the membrane. Finally, the suspension was cast on a glass plate using a 200 μm casting knife and the cast dope solution was placed in a DI water coagulation bath at 25° C.

TABLE 1
Composition of dope solutions prepared for composite membrane
casting as a percentage of the total mass of dope solution.

| | PES | SPES | PVP | Ti₃C₂Tₓ |
|---|---|---|---|---|
| | (wt %) | (wt %) | (wt %) | (wt %**) |
| PES | 16 | 0 | 2 | 0 |
| SPES | 0 | 16 | 2 | 0 |
| SM5 | 0 | 16 | 2 | 5 |
| SM10 | 0 | 16 | 2 | 10 |
| SM15 | 0 | 16 | 2 | 15 |

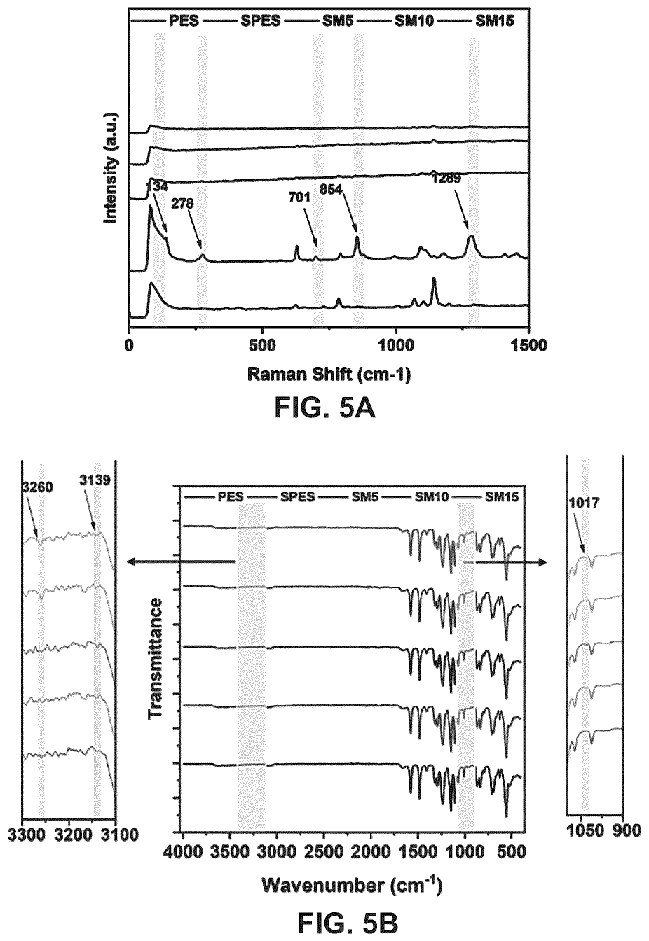

FIG. 5A illustrates Raman spectra for SPES/Ti₃C₂Tₓ composites and other membrane materials, according to some embodiments. FIG. 5B illustrates Fourier Transform Infrared (FTIR) spectra, according to some embodiments. Raman spectroscopy and FTIR were used to confirm sulfonation in the fabricated membranes. Raman spectroscopy allows the study of stereo-singularity and chain confirmation of the material so that the differences in the structure of PES and SPES can be seen. Since PES loses its symmetric structure upon sulfonation, additional peaks are displayed in the spectrum that are due to sulfonate groups (FIG. 5A). First, several Raman peaks occurred due to the asymmetric C—O—C stretch vibration peaks at about 1011 cm⁻¹. Additionally, an SO₂ stretch vibration peak was observed at 1100 cm⁻¹. Finally, a peak at 785 cm⁻¹ was attributed to the C—S—C symmetric stretching. The main peaks that distinguish PES and SPES have been shown in FIG. 5A and are at Raman shifts of 134 cm⁻¹, 278 cm⁻¹, 702 cm⁻¹, 854 cm⁻¹, and 1289 cm⁻¹. The shifts around 134 cm⁻¹ and 278 cm⁻¹ correspond to the vibrational mode of ρ(SO₃) and v(SC); respectively. Extra peaks in the 800 cm⁻¹ regions, specifically 702 cm⁻¹ and 854 cm⁻¹, indicate the presence of p-substituted sulfonic acid groups, confirming not only the sulfonation but also the structure in FIG. 4B. Finally, the peak at 1289 cm⁻¹ was assigned to v (SO₂) asymmetric stretching mode of the sulfonic acid moiety. Similarly, FTIR can identify polymers based on stretching and vibrational bonds in the functional groups. For example, the peaks at 1100 cm⁻¹ and 1200 cm⁻¹ are due to S═O stretching, while O—C—O stretching and vibration were observed at 1320 cm⁻¹. C—C stretching and aromatic skeleton vibration were indicated at 1490 cm⁻¹.

Secondary amines and sulfones led to several bands at 1150 cm⁻¹, 1240 cm⁻¹, 1300 cm⁻¹, and 1410 cm⁻¹. Peaks at 3500 cm⁻¹ corresponded to stretching vibration absorption of hydroxyl groups on the surface. Three minor peaks reflected the difference between PES and SPES-based membranes, occurring at 10¹⁷ cm⁻¹, 3260 cm⁻¹, and 3139 cm⁻¹. The absorption peak at 10¹⁷ cm⁻¹ in SPES represents the asymmetric vibrations of the —SO₃H group in the polymer chains, while the stretching of the hydroxyl group of the sulfonate group is clearly seen at 3260 cm⁻¹ and 3139 cm⁻¹. When the surface was analyzed by FTIR and Raman spectroscopy, no major peaks were observed that can be attributed to the incorporation of Ti₃C₂Tₓ into the SPES membranes. This indicates that Ti₃C₂Tₓ is distributed in the bulk of the membrane.

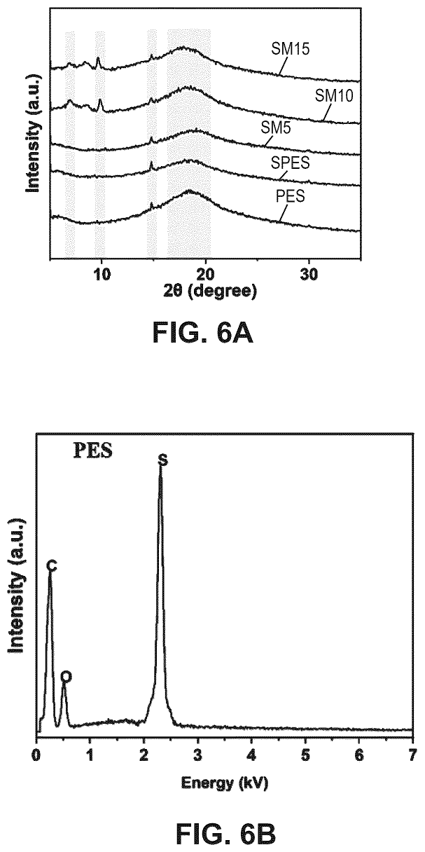

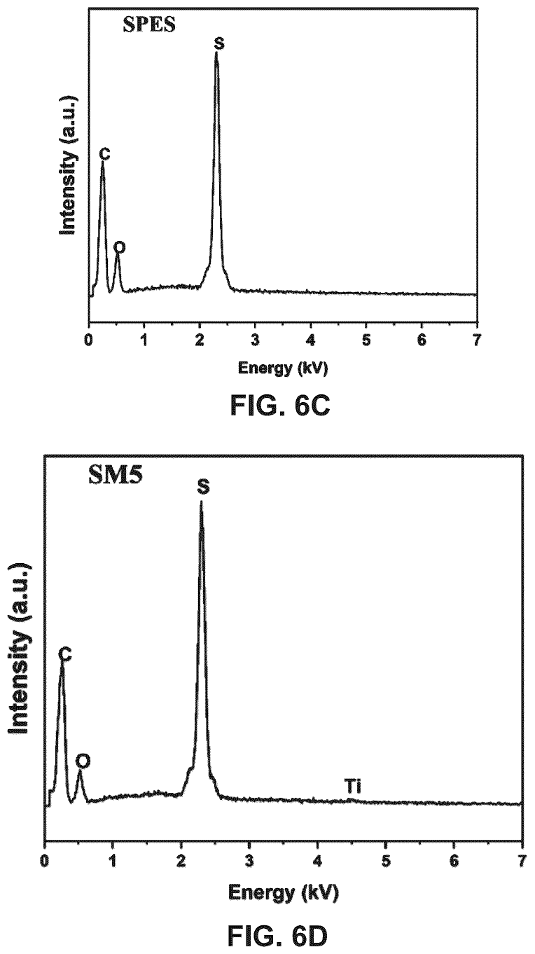

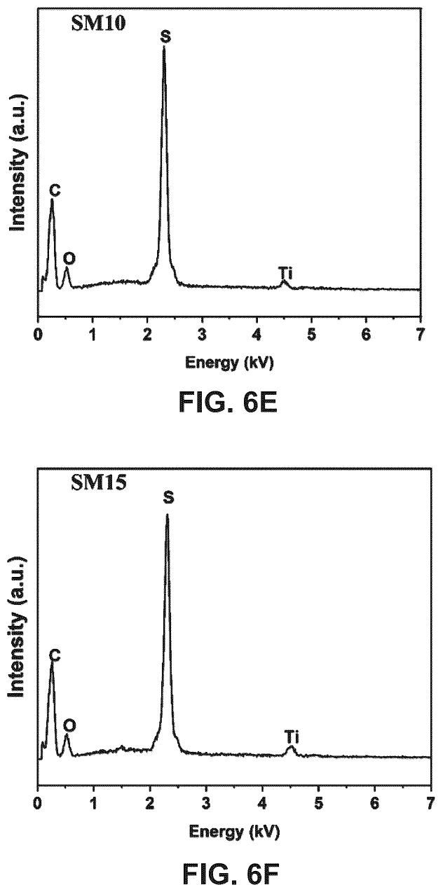

FIG. 6A illustrates x-ray powder diffraction (XRD) diffractograms of PES, SPES, and SPES/Ti₃C₂Tₓ composites, according to some embodiments. XRD and EDS analysis were used to confirm the Ti₃C₂Tₓ loading in the SPES membranes. The major peaks in the XRD diffractogram are at a 20 of 6.9°, 10.3°, 14.8° and 18.6°. There is no major difference between the PES and SPES spectra, which showed amorphous peaks at 14.8° and 18.6°. This indicates that PES and SPES have low crystallinity and that the crystal structure of the material has not changed significantly as a result of sulfonation. The peak at 14.8° can be attributed to PVP, while the peak at 18.6° was attributed to PES and SPES. The peaks at 6.9° and 10.3° correspond to planes (002) and (004), respectively, confirming the presence of the incorporated Ti₃C₂Tₓ nanomaterial. The intensity increases with increasing Ti₃C₂Tₓ loading, and there is additional peak broadening. In one example, this reflects the loss of crystallinity of Ti₃C₂Tₓ when it is incorporated into SPES.

FIG. 6B illustrates energy-dispersive x-ray spectroscopy (EDS) spectra of PES, according to some embodiments. FIG. 6C illustrates EDS spectra of SPES, according to some embodiments. FIG. 6D illustrates EDS spectra of SM5, according to some embodiments. FIG. 6E illustrates EDS spectra of SM10, according to some embodiments. FIG. 6F illustrates EDS spectra of SM15, according to some embodiments. The occurrence of the Ti peak with increasing Ti₃C₂Tₓ concentration confirms the presence of Ti₃C₂Tₓ and the resulting loading of the nanosheets. In addition, the results of elemental analysis are given in Table 2, showing:(1) an increase in sulfur content in SPES, SM5, SM10, and SM15 and (2) an increasing Ti concentration proportional to loading. Finally, the elemental mapping on the membrane surface shows a homogeneous distribution of all elements in each membrane, including Ti.

TABLE 2
Elemental analysis of fabricated membranes based on wt %.

| | PES | SPES | SM5 | SM10 | SM15 |
|---|---|---|---|---|---|
| Element | wt % | wt % | wt % | wt % | wt % |
| C K | 63.83 | 63.6 | 64.72 | 61.06 | 60.26 |
| O K | 12.43 | 7.2 | 7.09 | 6.81 | 7.11 |
| S K | 23.75 | 29.19 | 27.57 | 30.56 | 29.62 |
| Ti K | — | — | 0.63 | 1.57 | 3.01 |

The static water contact angle (WCA) (θ; °) was obtained using a drop shape analyzer and measured by the sessile drop method. The WCA was measured at 5 different locations, and the average values were reported. The dynamic WCA was recorded by tracking the contact angle for 120 s in 2 s intervals. The surface free energy (−ΔG_{SL}) was determined from the static contact angle using Eq. (1):

$$- Δ {G}_{SL} = ( 1 + cos θ ) {γ}_{L}^{T} \qquad ( 1 )$$

where, γ_{L}^{T} is the surface tension of water. The equilibrium water content (EWC) was calculated by measuring the weight of a membrane coupon before and after immersion in DI water. Eq. (2) was then used to obtain EWC:

$$σ = \frac{Ww - Wd}{Ww} \qquad ( 2 )$$

where, W_{W} stands for the wet weight and W_{d} for the dry weight of the membranes; respectively.

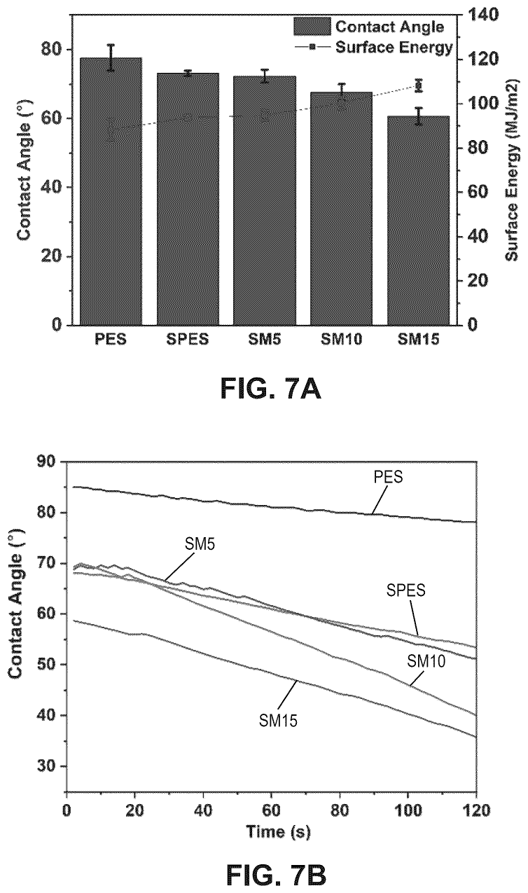

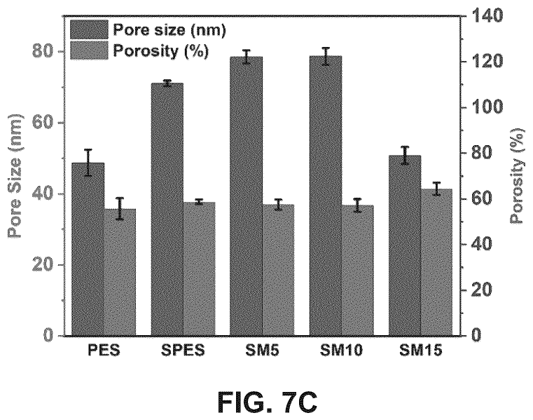

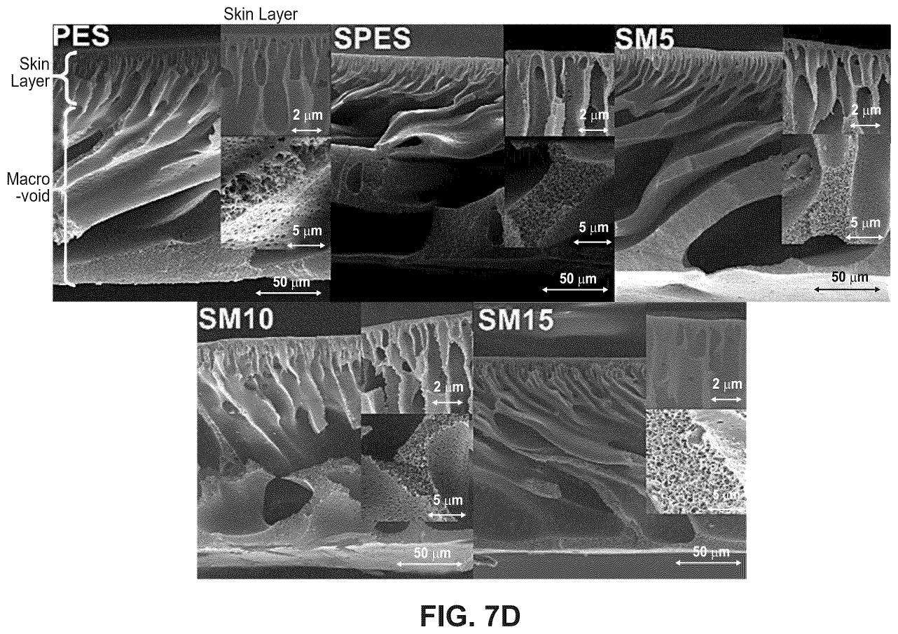

FIG. 7A illustrates the static contact angle and surface energy of PES, SPES, SM5, SM10, and SM15, according to some embodiments. First, it was observed that there is a considerable drop in the WCA from 78±4° (PES) to 73±1° (SPES) as a result of sulfonation. Additionally, there is a further decrease due to Ti₃C₂Tₓ incorporation to 72±2°, 68±2°, and 61±2° for SM5, SM10 and SM15 membranes, respectively. This is due to the presence of hydrophilic groups such as —OH, —O and —F in Ti₃C₂Tr. Higher surface energy leads to the formation of thicker hydration layer, which allows higher mass transfer of water through the membrane. The surface energy of the prepared membranes increased with sulfonation and incorporation of Ti₃C₂Tₓ nanomaterial. The SM15 membrane exhibited the highest surface free energy of 108±3 mJ.m⁻² compared to the PES membrane (88±5 mJ.m⁻²). FIG. 7B illustrates the dynamic contact angle of PES, SPES, SM5, SM10, and SM15, according to some embodiments. Moreover, when tracking the contact angle over a period of 120 min, a drop of 8.9%, 25.0%, 33.9%, 50.9%, and 47.2% of the initial contact angle was observed. This clearly shows that by increasing the Ti₃C₂Tₓ composition, the surface becomes highly hydrophilic.

The hydrophilic —SO₃H groups as a result of sulfonation and the —O and —OH groups from Ti₃C₂Tₓ resulted in a lower contact angle and higher surface energy. The additional hydrophilic functional groups also affect the rate of exchange between solvent (NMP) and nonsolvent (water) during phase inversion, which can determine the pore structure of the membrane. The porosity (ε; %) was obtained using gravimetric analysis, where a membrane coupon of known dimensions is immersed in a wetting liquid. The wetting liquid displaces air inside the pores; thus, the pore volume can be obtained from the weight difference in the coupon before and after immersion. Therefore, porosity can be obtained from the ratio of the pore volume to the volume of the membrane coupon using Eq. (3):

$$ε = \frac{{m}_{1} - {m}_{2}}{A \cdot δ \cdot ρ} \times 100 \% \qquad ( 3 )$$

where, m₁ and m₂ are the weights of the wet and dry membrane respectively (g), A is the area of membrane coupon (m²), δ is the membrane thickness (m), and ρ represents the density of Galwick (1830 kg.m⁻³). The mean pore size (rₘ; m) was then obtained from the Guerout-Elford-Ferry equation (Eq. (4)):

$${r}_{m} = \sqrt{\frac{( 2.9 - 1.75 ε ) \cdot 8 ηδ Q}{ε \cdot A \cdot Δ P}} \qquad ( 4 )$$

where, η is the viscosity of water (8.9×10⁴ Pa·s), Q is the water flowrate (m³·s⁻¹), and ΔP is the operational pressure (Pa).

FIG. 7C illustrates the pore size and porosity of PES, SPES, SM5, SM10, and SM15, according to some embodiments. The thermodynamic instability and the kinetic hinderance of the dope solution determine this rate. The thermodynamic instability increases the exchange rate, resulting in a membrane with greater porosity and pore size, while the kinetic hindrance decreases it. Additional hydrophilic components, in this case-SO₃H groups in SPES, are drawn to the non-solvent (water) during phase inversion (water), which increases the thermodynamic instability. This explains the increase in porosity and pore size between PES and SPES.

Similarly, the Ti₃C₂Tₓ sheets contain hydrophilic functional groups such as —O, —OH and —F, which may form hydrogen bonds with water, and can increase the thermodynamic instability. Hence, there is another jump in the pore size in SM5 and SM10 compared to SPES as a result of the Ti₃C₂Tₓ incorporation. Overall, the pore size increased from 49±1 nm to 79±4 nm from PES to SM10. The porosity also increased slightly from 55±2% in PES to 57±1% in SM10. However, the increase in Ti₃C₂Tₓ concentration increased the viscosity of the dope solution, so that the kinetic hindrance takes over the thermodynamic instability. This explains the decrease in pore size from 79±4 nm to 50.8±5.1 nm in SM10 compared to SM15.

FIG. 7D illustrates cross-sectional scanning electron microscope (SEM) micrographs of PES, SPES, SM5, SM10, and SM15, according to some embodiments. The cross-sectional images also reflect the results: the macro-void layer in PES and SM15 exhibited more hindered paths compared to SPES, SM5 and SM10, resulting in a smaller average pore size. The cross-section showed a typical asymmetric membrane structure, where the skin layer had small finger-like pores for high selectivity and the macro-void layer had a larger pore for higher mass transfer. The top surface of the membrane exhibits a dense structure in all membranes. The bottom surface also exhibits a very porous structure due to asymmetry, with larger pores observed in SPES, SM5, and SM10 than in PES and SM15. Therefore, in one example, a lower percentage (such as in SM10 or SM5) may be used to overcome the kinetic hinderance and promote the thermodynamic instability of the dope solution when added to the non-solvent.

The thermal stability was increased by sulfonation and incorporation of Ti₃C₂Tr. The structural properties of the polymer chain were maintained due to the minimal changes in mechanical and thermal stability after sulfonation. However, a significant increase in tensile strength was observed for SM5, which was 42 MPa, while it was 32 MPa for SPES. This can be attributed to the strong interaction between the polar groups in SPES and Ti₃C₂Tₓ, which increased the overall strength.

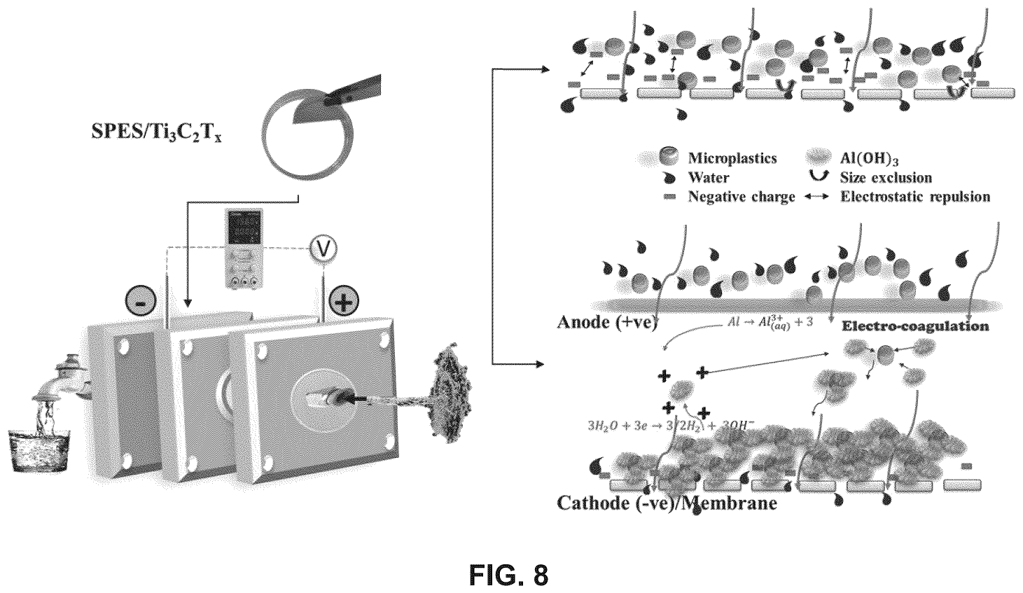

FIG. 8 illustrates a system for water filtration, according to some embodiments. As shown, an SPES/Ti₃C₂Tₓ composite filtration membrane and an aluminum anode were utilized. During operation, the aluminum is dissociated from the anode to generate Al³⁺. These Al³⁺ coagulants can combine with OH— to form hydroxyl Al ions. The hydroxyl group then polymerizes with another Al³⁺ to form a two hydroxyl bond bridge (Alₘ(H₂O)×(OH)ₙ^{(3m-n)+}). The mononuclear Al complex can further polymerize forming an amorphous flocculant Al(OH) 3. These complexes can capture and sweep microplastics by netting or entangling the microplastics in the water due to the large surface area and functional groups of the complex.

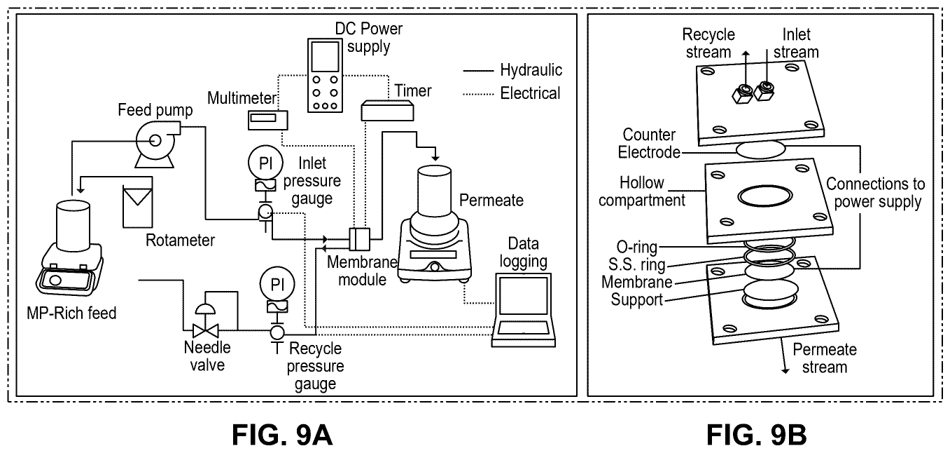

FIG. 9A illustrates a schematic of a cross-flow electrified filtration system, according to some embodiments. FIG. 9B illustrates components of the cell assembly, according to some embodiments. To prepare for the fouling tests, 1000 μg.L⁻¹ microparticle (MP) solution was prepared in 1000 ppm NaCl. This was done by first boiling a 0.1 wt. % Tween® 80/water solution, and subsequently adding an adequate amount of NaCl and polyethylene. A microplastic-rich solution was pumped into a cross-flow cell and recycled back into the feed, with a pressure gauge at the inlet and at the recycle stream. The applied pressure was adjusted via a needle valve at the recycle stream, and set to 1 bar throughout all experiments and monitored. The permeate was then collected and analyzed. The cell was connected to a multimeter, which was connected in series to a direct current (DC) power supply, and a timer for the intermittent mode of operation. The cell is composed of 2 acrylic sheets, with a hollow compartment in the middle to provide distance between the electrodes. The anode is a 25 mm diameter Al mesh disc, and the cathode includes the composite filtration membrane fixed by a stainless-steel ring for enhanced electrical conductivity.

To determine pure water permeability (PWP), a dead end stirred cell was utilized using DI water as feed and an effective membrane area (Aₑ) of 4.9 cm². A 30 min compaction period was performed using an applied pressure of 2 bar. Consequently, the pressure was reduced to 1 bar (ΔP), and the volume of the DI water collected (V) was measured in three 30 min intervals (Δt). The PWP was finally calculated using Eq. (5):

$$PWP ( L \cdot {m}^{- 2} \cdot {h}^{- 1} \cdot {bar}^{- 1} ) = \frac{V}{Δ P \times {A}_{e} \times Δ t} \qquad ( 5 )$$

The applied voltage was tested at 0 V, 2 V, and 5 V, and the flux (J) was calculated from the permeate mass using Eq. (6). For the initial flux, the mass was recorded at 30 min intervals, and an average flux was recorded. Subsequently, the effect of flux with time was recorded every minute for a period of 90 min. Based on the results obtained, the effective voltage was determined and an intermittent long-term study (7 h) was performed using the SM5 membrane and the pristine PES membrane.

$$J = \frac{M}{{A}_{m s} \times Δ t \times Δ P} \qquad ( 6 )$$

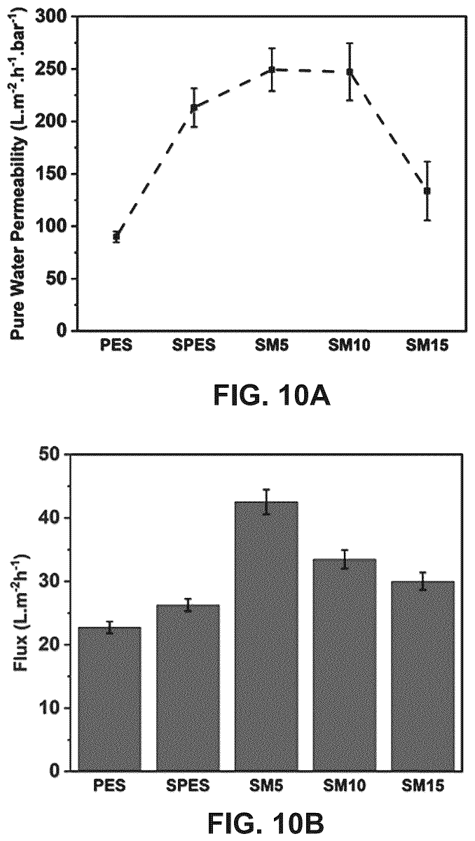

FIG. 10A illustrates the pure water permeability (PWP) of PES, SPES, SM5, SM10, and SM15, according to some embodiments. The PWP of each composite membrane was studied by applying a DI water feed at a pressure of 1 bar. It was found that the PWP increased from 89.9±5.2 (PES) to 213.1±18.4 (SPES) L.m⁻².h⁻¹.bar⁻¹ as a result of PES sulfonation. This is expected since an increase in surface energy was observed, leading to a thicker hydration layer and higher mass transfer across the membrane. Comparing SPES with PES, the transition to finger-like pores is shorter in SPES than in PES. In addition, the micro-void layer in SPES is less hindered compared to PES. These two observations are consistent with the higher PWP in SPES. Moreover, a similar trend is expected with increasing Ti₃C₂Tₓ content from SM5 to SM15.

A membrane characterized with higher pore size and porosity exhibits an increase in the interlinked void spaces. This, in turn, typically facilitates higher flux and enhanced permeability. More pores mean more pathways for the substance to travel through, resulting in increased transport rates. However, excessively high porosity might lead to reduced structural stability. Hence, a balanced distribution of small and large pores can enhance the overall transport efficiency. Smaller pores may block larger molecules, while larger pores might allow faster movement of smaller molecules. In one example, while this trend was observed in SM5 and SM10, where increased membrane hydrophilicity resulted in a higher PWP (249.3±20.3 and 247.3±27.3 L.m⁻².h⁻¹.bar⁻¹, respectively), this trend was broken in SM15, where a PWP of 133.5±28.0 L.m⁻².h⁻¹.bar⁻¹ was reported. This is due to the predominant effect of decreasing pore size versus the effect of increased surface energy, resulting in a lower PWP.

FIG. 10B illustrates the flux of microplastic-rich suspensions using PES, SPES, SM5, SM10, and SM15, according to some embodiments. A similar trend to PWP was observed. However, SM10 exhibited slightly lower flux compared to SM5, despite higher hydrophilicity and similar mean pore size and porosity. This may be due to the denser skin layer, as shown in FIG. 7D, such that the microplastics blocked the pores on the surface and further hindered water transfer across the membrane. This is also reflected in the EWC of SM5 compared with SM10, where an EWC of 60.3±1.4% and 56.7+0.7% was reported for SM5 and SM10, respectively. Further, the effects of both porosity and contact angle are reflected in the EWC. An additional phenomenon contributing to an increased flow rate when utilizing the suspension rich in microplastic is electrostatic repulsion. This occurs due to the negative charge present on the PES material, which causes a mutual repulsion between the negatively charged microparticles. Through sulfonation, the overall surface charge experiences a reduction of 9.4 mV at a pH level that is neutral. Furthermore, the introduction of Ti₃C₂Tₓ into the system leads to a notable decrease in surface charge, with a value as low as −39.6±0.5 mV. Thus, it can be seen that a combination of surface hydrophilicity, surface charge, and pore structure led to the trends shown in FIGS. 10A-10B.

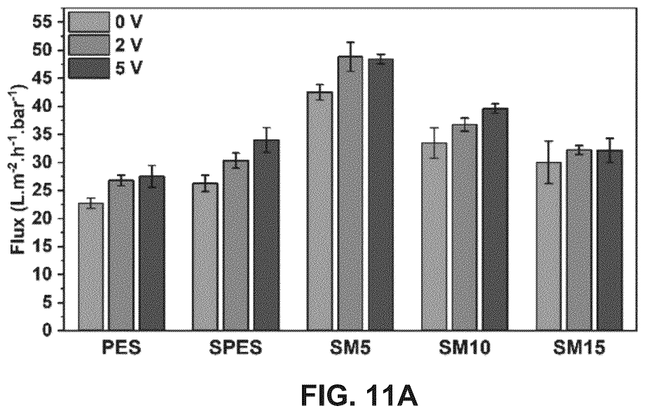

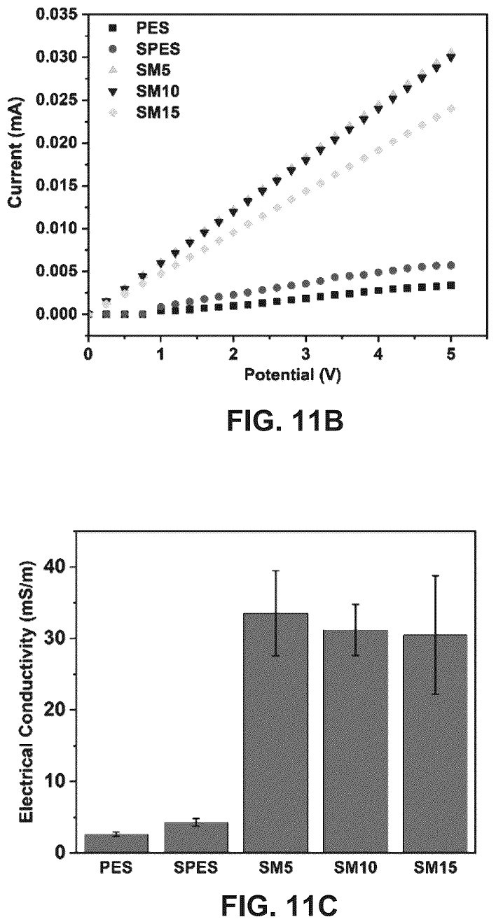

FIG. 11A illustrates the effect of voltage on cross-flow filtration flux of a microplastic-rich suspension, according to some embodiments. These trends are consistent with the PWP results, where a higher flux was recorded at all applied voltages for SPES, SM5, SM10, SM15 compared to PES. Second, a steady increase in the water flux with increasing applied voltage for all membranes was observed. The increase in initial water flux as a result of increasing applied voltage can be attributed to the higher negative charge applied by the DC electric field.

When an electric field is applied to a surface, it can induce a charge redistribution on the surface. This redistribution can result in an increase or decrease in the surface charge negativity, depending on the material, strength and polarity of the applied electric field. For example, if the material is a conductor, the electrons in the material can move in response to the applied electric field, causing a redistribution of charge on the surface. This can lead to an increase in the surface charge negativity. Consequently, the negatively charged microplastics repel away from the surface at a higher applied voltage, minimizing concentration polarization on the surface and allowing for a higher flux.

The current-voltage (I-V) characteristics were studied. The voltage was varied from 0 to 5 V, and the current was recorded. The electrical conductivity (σ; S.cm⁻¹) was obtained from the measured resistance using Eq. (7):

$$σ = \frac{d}{R \times A} \qquad ( 7 )$$

where, d is the distance between the electrodes (cm), R is the resistance of the membrane obtained from the I-V curve (Ω), A is the cross-sectional area of the membrane (cm²).

FIG. 11B illustrates potential and current characteristics of PES, SPES, SM5, SM10, and SM15, according to some embodiments. FIG. 11C illustrates the electrical conductivity of PES, SPES, SM5, SM10, and SM15, according to some embodiments. FIG. 11C shows that the electrical conductivity dropped at SM15 compared to SM10 and SM5. This may be attributed to the aggregation of Ti₃C₂Tₓ nanosheets at high concentrations, resulting in restrictions on the conductive networks. In addition, the restricted membrane mean pore size and surface non-homogeneity due to stacking and agglomeration further concealed the effect of increasing voltage. The applied electric field resulted in enhanced electrostatic repulsion between the membrane surface and the microplastics, therefore limiting the interaction between the membrane surface and the negatively charged microplastics, increasing the flux.

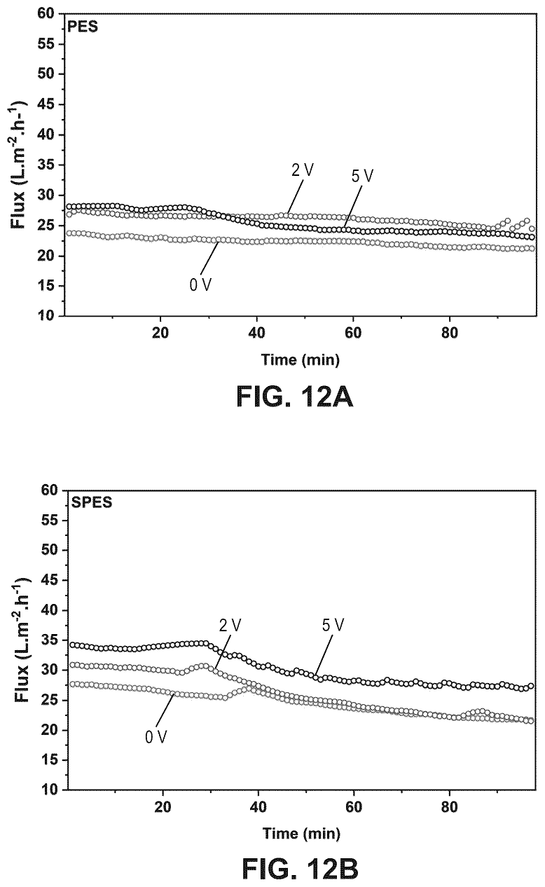

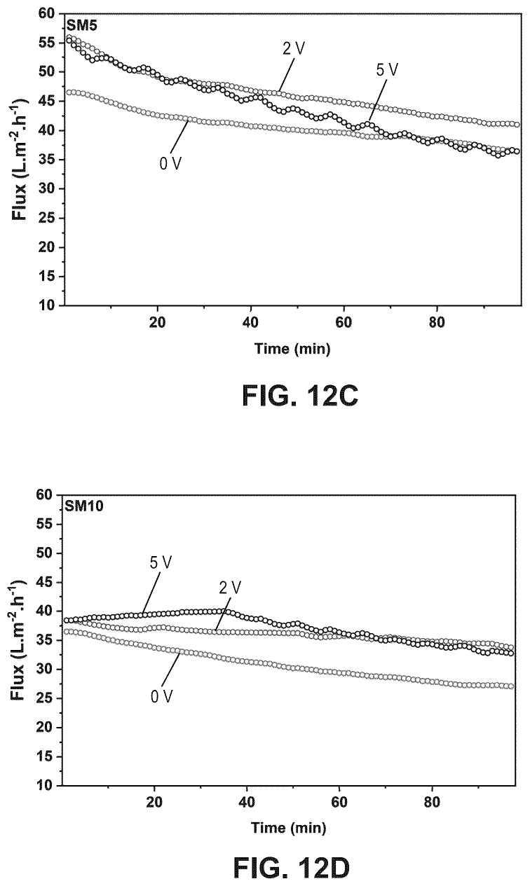

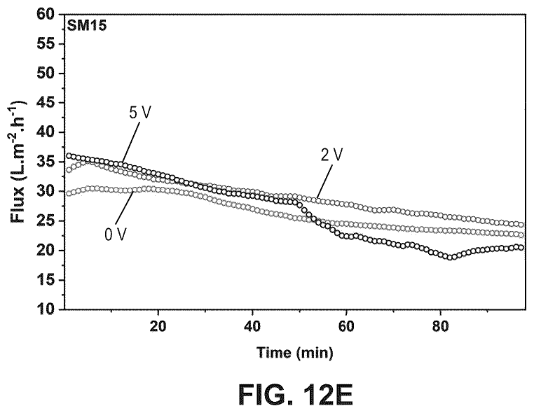

FIG. 12A illustrates the long-term effect of applied voltage on cross-flow filtration flux of micro-plastic rich suspensions using PES, according to some embodiments. FIG. 12B illustrates the long-term effect of applied voltage on cross-flow filtration flux of micro-plastic rich suspensions using SPES, according to some embodiments. FIG. 12C illustrates the long-term effect of applied voltage on cross-flow filtration flux of micro-plastic rich suspensions using SM5, according to some embodiments. FIG. 12D illustrates the long-term effect of applied voltage on cross-flow filtration flux of micro-plastic rich suspensions using SM10, according to some embodiments. FIG. 12E illustrates the long-term effect of applied voltage on cross-flow filtration flux of micro-plastic rich suspensions using SM15, according to some embodiments.

Looking at the long-term results in FIGS. 12A-12E, the water flux of all membranes slowly decreased over a 90-min period. Generally, the water flux decline increases over time, especially at 5 V compared to 2 V and 0 V. By taking the flux recovery ratio (FRR) as the ratio of flux at 90 min to 0 min, it can be seen that the ratio dropped from 0.9 to 0.8, 0.8 to 0.7, 0.8 to 0.8, and 0.8 to 0.6 for PES, SPES, SM5, and SM15; respectively as the applied voltage increased from 0 to 5 V. Therefore, the initial flux increased at 5 V due to electrostatic repulsion, however the flux dropped faster at 5 V compared to 0 V. Additionally, a higher membrane conductivity resulted in a higher water flux, however a similar trend was observed through which a lower FRR was reported. A higher membrane conductivity resulted in a higher flux at 0 min, but the flux dropped faster after 90 min. The drop in flux overtime may be attributed to the dissociation of Al in at the anode, and water at the cathode, where the electrically generated Al³⁺ coagulants combine with OH— to form hydroxyl Al ions.

The hydroxyl group polymerizes with another Al³⁺ to form two hydroxyl bond bridge (Alₘ(H₂O)×(OH)ₓ^{(3m-n)+}). The mononuclear Al complex can further polymerize forming an amorphous flocculant ([Al(OH)₃]ₙ). A high degree of polymerization captures and sweeps microplastics by netting or entangling due to the complex's large surface area and functional groups. The large surface area of the complex allows for more effective binding and removal of the microplastics from the water. A lower degree of polymerization, on the other hand, captures microplastics by adsorption. The negatively charged microplastics are adsorbed onto the mononuclear Al complexes such as Al(H₂O)₅OH²⁺, Al(H₂O)₄OH²⁺, Al(H₂O)₃OH²⁺, etc. At a higher applied voltage, more Al³⁺ coagulants were formed; therefore, a lower degree of polymerization is expected. As a result, the coagulation mechanism shifts towards more adsorption, as the smaller polymer molecules are more likely to adsorb onto the surface of the microplastics, rather than forming larger flocs through netting or entanglement. A lower applied voltage on the other hand favors higher degree of polymerization, therefore, larger flocs are formed which can be swiped off the membrane surface. For example, this shows that 2 V was favored over 5 V, where larger flocs are formed.

Additionally, the production of gas bubbles during the electrocoagulation process can also affect the degree of polymerization and floc size. At higher voltages, the bubble production rate can increase with time due to the electrolysis of water. The bubbles generated can scavenge the polymer molecules, which can reduce the rate of polymerization and ultimately result in smaller flocs. This occurs because the bubbles provide a surface area on which the polymers can adsorb onto, which removes them from the solution and reduces their availability to participate in netting and entanglement with microplastics. As a result, it was observed that at 5 V, the coagulation mechanism shifts toward greater adsorption and smaller floc sizes. An additional phenomenon that aids in reducing fouling at applied voltage is electroosmosis, where bound water is extracted from flocs. This results in floc dehydration, which makes it less hydrophilic, and the attachment to the surface is minimized. Therefore, it is concluded that applied voltage has the potential to recover the lost flux. Additionally, 2 V over a 30-min period are sufficient to maintain the flux, as this is an excellent applied voltage and time required for a higher degree of polymerization, thus, capturing and sweeping the microplastics by netting.

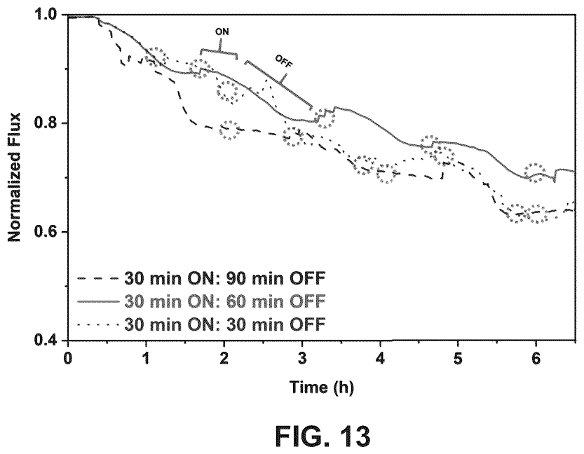

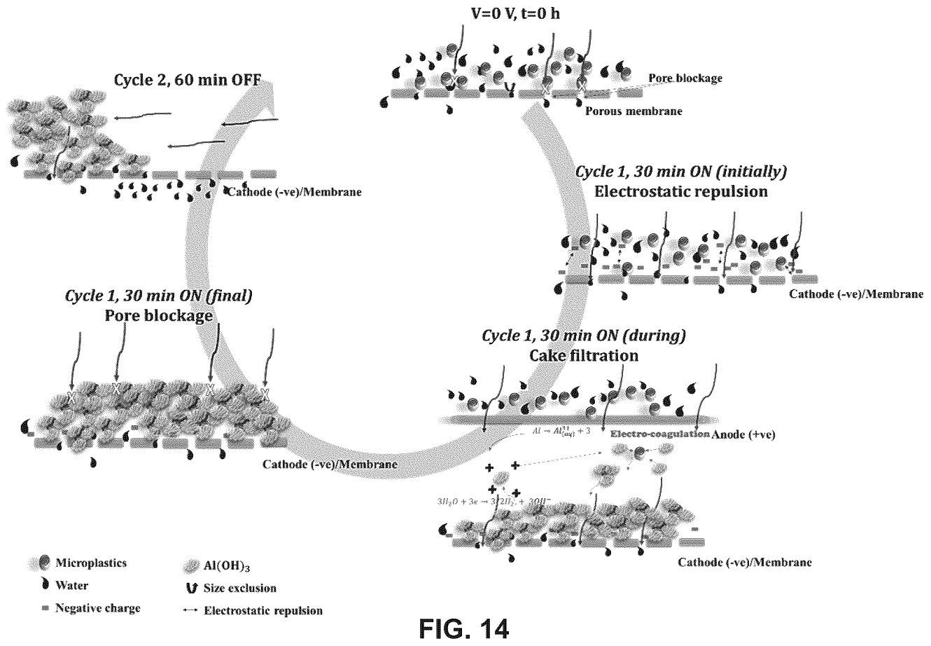

The SM5 membrane proved to be the best membrane in terms of PWP and flux at all applied voltages, with 2 V being sufficient to improve flux compared with 0 V. However, after 30-min of operation, the water flux decreased significantly. Therefore, intermittent operation was applied to SM5, at 2 V, at 30 min ON: 30 min OFF, 30 min ON: 60 min OFF, and 30 min ON: 90 min OFF. FIG. 13 illustrates cross-flow filtration flux of microplastic-rich suspensions using SM5 in intermittent applied voltage mode, according to some embodiments. FIG. 14 illustrates a mechanism for the effect of intermittent voltage on the membranes of the present disclosure, according to some embodiments. A cyclic study was performed over a 7 h period. A decrease in flux over time was observed for all modes. This is due to the highly hydrophobic nature of the microplastics, which tend to accumulate on the membrane surface and block the pores. Therefore, strong surface adsorption and pore blockage occurred during the first 30 min of OFF time. Once the voltage was turned ON, an increase in flux was observed. This is related to the electrostatic repulsion exerted on the negatively charged microplastics by the electric field at the negatively charged membrane cathode.

During the 30 min ON time, the Al³⁺ ions have dissolved and polymerized with the hydroxyl groups formed at the cathode, forming an in-situ flocculant that forms large flocs with the microplastics in the bulk solution. Therefore, pore blockage is terminated and large flocs form a cake creating a heterogenous surface. Cake filtration maintains the flux for 30 min. However, when excessive flocs form on the membrane surface, the cake layer becomes thick and causes the flux to decrease. Therefore, when the electric field is turned off, the flocs are removed from the surface and the cycle starts again. In the mode “30 min ON: 30 min OFF”, a time interval of 30-min OFF may not be sufficient to sweep the large flocs off the surface. In contrast, in the mode “30 min ON: 90 min OFF”, a 90 min interval removes the in-situ heterogeneous cake layer and allows the membrane pores on the surface to be blocked. It can be concluded that a 60 min OFF interval sweeps the large microplastic flocs from the surface and maintain a sufficient floc layer for cake filtration, thus improving the flux.

The phenomena observed demonstrates that the use of SPES/Ti₃C₂Tₓ composite membranes can introduce and maintain an in-situ cleaning process without the need for additional chemicals such as flocculants or cleaning agents. In addition, membrane operation does not need to be interrupted to perform backwashing or add chemicals when the water is rich in microplastics. In addition, a higher conductivity membrane reduces the optimal intermittent ON time required and reduces the voltage requirements, therefore enhancing the overall efficiency of the process. This is because a higher degree of mononuclear Al polymerization is favored at lower voltages in more conductive membranes. Conductivity usually also comes at the expense of permeability. Therefore, higher water permeability and conductivity are expected when using the membranes of the present disclosure, thus improving and maintaining the overall flux.

Importantly, SPES/Ti₃C₂Tₓ membranes are fabricated herein to enhanced conductivity, thus minimizing the overall energy consumption without compromising the flux. Sulfonation and incorporation of Ti₂C₃Tₓ resulted in higher flux due to additional hydrophilic groups such as —SO₃H, —OH and —O. The conductivity of the membrane was significantly improved due to the excellent metallic conductivity of Ti₃C₂Tr. It was found that 2 V applied potential for a period of 30 minutes was sufficient to increase and maintain water flux by at least 90%. Performance tests showed that flux increased from 42 L.m⁻².h⁻¹ at 0 V to 49 L.m⁻².h⁻¹ at 2 V when 5 wt % Ti₃C₂Tₓ was used in conjunction with an applied electric field due to electrostatic repulsion. A membrane with a higher conductivity required less time and voltage to maintain flux. In addition, it was found that the use of an intermittent voltage at time intervals of 30 min resulted in a more stable flux because it allowed for in situ coagulant formation and an in-situ cleaning procedure without the need for additional chemicals such as flocculants or cleaning agents.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

What is claimed is:

1. A composite filtration membrane, the composite filtration membrane comprising:
sulfonated polyethersulfone (SPES) and one or more MXenes.

2. The composite filtration membrane of claim 1, wherein the one or more MXenes follow the formula:Mₙ₊₁XₙTₓ, where M is selected from Ti, V, Cr, Y, Zr, Nb, Mo, Hf, Ta, and W; X is C or N; Tₓ is at least one of OH, O, F, and Cl; and n is 1, 2, or 3.

3. The composite filtration membrane of claim 2, wherein the one or more MXenes follow the formula:Ti₃C₂Tₓ, wherein Tₓ is at least one of OH, O, F, and Cl.

4. The composite filtration membrane of claim 1, wherein the one or more MXenes include titanium, and wherein the weight percentage of MXene in the composite filtration membrane ranges from about 0.2 wt. % to about 20 wt. %.

5. The composite filtration membrane of claim 1, wherein the composite filtration membrane is an ultrafiltration membrane with an average pore size ranging from about 1 nm to about 100 nm.

6. A filtration apparatus, the filtration apparatus comprising:
a cathode, wherein the cathode includes a composite filtration membrane including a polymer and one or more MXenes; and
a sacrificial anode.

7. The filtration apparatus of claim 6, wherein the composite filtration membrane is an ultrafiltration membrane.

8. The filtration apparatus of claim 6, wherein the polymer includes polyethersulfone (PES).

9. The filtration apparatus of claim 6, wherein the polymer includes sulfonated polyethersulfone (SPES).

10. The filtration apparatus of claim 6, wherein the one or more MXenes include an MXene with the following formula: Ti₃C₂Tₓ, wherein Tₓ includes at least one of OH, O, F, and Cl.

11. The filtration apparatus of claim 6, wherein the sacrificial anode includes one or more of iron and aluminum.

12. The filtration apparatus of claim 6, wherein the filtration apparatus is capable of electrocoagulating microparticles in water.

13. A method of filtering water, the method comprising:
providing a filtration system including a cathode and an anode; and
contacting water with the cathode and the anode, to produce a permeate stream, wherein the cathode includes a composite filtration membrane including a polymer and one or more MXenes.

14. The method of claim 13, wherein the polymer includes a sulfonated polymeric material.

15. The method of claim 13, wherein the one or more MXenes include an MXene with the following formula: Ti₃C₂Tₓ, wherein Tₓ includes at least one of OH, O, F, and Cl.

16. The method of claim 13, wherein the anode is a sacrificial anode including one or more of iron and aluminum.

17. The method of claim 13 further including applying a voltage to the cathode, wherein the voltage ranges from about 0.1 volts to about 5 volts.

18. The method of claim 17, wherein the voltage is applied in an intermittent operation.

19. The method of claim 13, wherein the filtration system is capable of ultrafiltration and electrocoagulation of microparticles in water, and wherein the permeate stream is transferred to a downstream reverse-osmosis system.

20. The method of claim 19, wherein the microparticles include microplastics.
